(19) United States
(12) Patent Application Publication
(10) Pub. No.: US 2002/0131666 A1
(43) Pub. Date: Sep. 19, 2002

(54) Non-reciprocal phase shifter

(76) Inventors: Henry Hung, Paradise Valley, AZ (US); Yallapu Anjan, Scottsdale, AZ (US)

Correspondence Address: DONALD J. LENKSZUS, P.C., P.O. Box 3064, Carefree, AZ, 85377-3064, US

(21) Appl. No.: 09/811,975

(22) Filed: Mar. 19, 2001

(51) Int. Cl. G02F 1/295

(52) U.S. Cl. 385/6

(57) ABSTRACT

A non-reciprocal optical phase shifter comprises a plurality of switchable phase shifter stages. Each phase shifter stage is optically coupled to an adjacent phase shifter stage. At least one phase shifter stage produces a fixed Faraday rotation on the optical signal components. The plurality of switchable phase shifter stages is optically coupled to at least one phase shifter stage to produce a cumulative non-reciprocal phase shift that is the summation of the phase shifts of the plurality of switchable phase shifter stages and the at least one phase shifter stage.

### FIELD OF THE INVENTION

This invention pertains to optical phase shifters, in general, and to optical non-reciprocal phase shifters, in particular.

### BACKGROUND OF THE INVENTION

A non-reciprocal phase shifter introduces a predetermined phase shift into an optical signal propagating in one direction and a different predetermined phase shift into an optical signal propagating in the opposite direction. In some instances, the magnitude of the phase shift in both directions is the same, but the shifts are of opposite sign.

Non-reciprocal phase shift is based on the principle of Faraday rotation. With Faraday rotation, the angle of rotation is defined as θ=νBl. B is the magnetic flux density, ν is the constant of proportionality known as the Verdet constant, and l is the length of the crystal. The Verdet constant is a measure of a crystal's ability to rotate the plane of polarization of optical signals. The direction of rotation depends on whether light propagation is parallel or anti-parallel to the magnetic flux density.

Applications of Faraday rotation include optical isolators and circulators. An optical isolator prevents or reduces the backward reflected light. A circulator directs light from one port to the next only one way. Both isolators and circulators are non-reciprocal devices. Most applications use 45 degrees rotation, which is achieved by using bulk crystals such as Yttrium Iron Garnet (YIG) or thin film crystals such as Bismuth Iron Garnet (BIG). The thickness, l, of a crystal is selected to provide 45 degrees rotation in a saturating magnetic field.

Typical Faraday rotation of a crystal as a function of the magnetic field follows a hysteresis loop extending from −45 degrees to +45 degrees. With the crystal length, l, cut for 45 degrees rotation, the state of polarization is well defined when a saturating magnetic field is applied to the crystal in either direction. However, in a zero magnetic field, and at in between saturations, the rotation is not defined.

Optical non-reciprocal phase shifters are useful in a variety of applications including telecommunications and optical gyroscopes. It is highly desirable to provide a non-reciprocal phase shifter that is easy to manufacture, small in size and inexpensive.

### SUMMARY OF THE INVENTION

In accordance with the principles of the invention, a non-reciprocal optical phase shifter comprises a plurality of switchable phase shifter stages. Each phase shifter stage is optically coupled to an adjacent phase shifter stage. At least one phase shifter stage produces a fixed Faraday rotation on the optical signal components. The plurality of switchable phase shifter stages is optically coupled to at least one phase shifter stage to produce a cumulative non-reciprocal phase shift that is the summation of the phase shifts of the plurality of switchable phase shifter stages and the at least one phase shifter stage.

Each switchable phase shifter stages comprises a Faraday crystal and a corresponding electromagnet. At least one phase shifter stage comprises at least one Faraday crystal and a corresponding non-switchable magnet.

In one embodiment of the invention, a non-reciprocal optical phase shifter, comprises a plurality of phase shifters arranged in pairs. Each phase shifter pair comprises: first and second Faraday rotation crystals; a non-switchable magnet proximate the first Faraday rotation crystal; and a switchable magnet proximate the second Faraday rotation crystal. The first and second Faraday rotation crystals are optically coupled. The plurality of phase shifters are optically coupled together whereby the output of said non-reciprocal phase shifter is the summation of phase shifts of the plurality of phase shifters.

In accordance with one aspect of the invention, a non-reciprocal optical phase shifter, comprises a first phase shifter providing a fixed Faraday rotation to optical signals propagating there through; a plurality of second phase shifters optically coupled to the first phase shifter and to each other, each of the second phase shifters is operable to provide a cumulative switchable phase shift. The first phase shifter comprises a Faraday rotation crystal and a permanent magnet subjecting the Faraday rotation crystal to a fixed magnetic flux.

### BRIEF DESCRIPTION OF THE DRAWING

The invention will be better understood from a reading of the following detailed description in conjunction with the drawing figures in which like reference numerals are used to designate like elements, and in which:

FIG. 1 is a cross-section of a non-reciprocal phase shifter in accordance with the Invention; and

FIG. 2 is a cross-section of a second non-reciprocal phase shifter in accordance with the invention.

### DETAILED DESCRIPTION

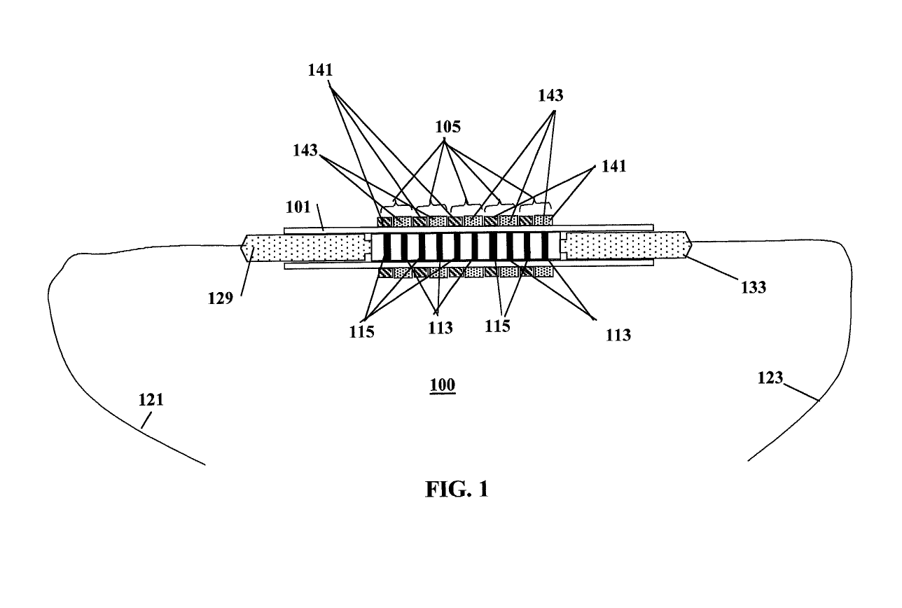

An embodiment of a non-reciprocal phase shifter (NRPS) 100 in accordance with the invention is shown in FIG. 1. NRPS 100 is a hermetically sealed unit that includes tubular aluminum housing 101. Optical signals are coupled to and from the non-reciprocal phase shifter 100 via optical waveguides 121, 123, which in the particular embodiment shown are optical fiber. However, in other embodiments, one or both of the waveguides 121, 123 may be waveguides formed on a substrate and the non-reciprocal phase shifter may be formed on the substrate also as an integrated optic device. Optical fiber 121 is coupled to collimator 129. The particular manner in which fiber 121 is affixed to collimator 129 may be any of the various known methods of attaching optical fibers such as epoxy bonding. The particular details of how fiber 121 is attached to collimator 129 is not important to this invention. Similarly, optical fiber 123 is coupled to collimator 133.

In accordance with the principles of the invention, a plurality, N, of non-reciprocal phase shifter stages are provided. The phase shifter stages are disposed within the optical signal path between collimators 129, 133. In the embodiment of FIG. 1, the phase shifter stages are arranged in pairs 105. Each phase shifter pair 105 includes two Faraday rotation crystals 113, 115. Faraday rotation crystals are known in the art. In the embodiment shown, A plurality of permanent magnets 141 is provided. Each magnet 141 is ring shaped and each is positioned concentric with a corresponding one Faraday rotation crystal 115. In addition, a plurality of electromagnets 143 is provided. Each electromagnet is positioned concentric with a corresponding one Faraday rotation crystal 113. Each electromagnet is a wire coil or solenoid.

The magnetic field for each electromagnet 143 produces a magnetic flux density B in its corresponding crystal 113. The magnetic field produced by each electromagnet 143 is that of a long solenoid and is characterized by B=μ₀ i n, where μ₀ is permeability of free space, i is the current through the coil, and n is the number of turns per unit length.

The switching time constant for a coil is τ, with τ=L/R, where L is the inductance and R is the resistance of the coil. The inductance L is determined by L=μ₀ n² l A, where n is the number of turns per unit length, l is the length of the coil, and A is the cross-sectional area of the coil. The resistance, R, is determined from R+ρl/A, where p is the resistivity of the material used for the wire, typically copper, l is the length of the wire, A is the cross-sectional area of the wire. Time constant τ, is thus proportional to n, the number of turns per unit length. To speed up the switching time the number of turns is reduced. By reducing the number of turns, the magnetic flux density is decreased. With a decreased magnetic flux density, the thickness of each Faraday rotation crystal needs to be reduced to provide for a hysteresis loop that saturates at the decreased magnetic flux density.

In accordance with the principles of the invention a higher speed non-reciprocal phase shifter is obtained by providing a plurality of optically coupled non-reciprocal phase shifters 105, each phase shifter providing a portion of the total phase rotation. With N phase shifters, and a desired maximum phase shift of 90 degrees, each phase shifter must provide fixed and switchable rotations of 90/N, where N is the number of phase shifters. For 10 phase shifters arranged as 5 phase shifter pairs 105, each permanent magnet produces a fixed rotation of θ=90/N, and each switchable magnet produces a switchable magnetic field to switch rotation such that θ=+/−90/N. With five phase shifter pairs 105, to produce an angle of rotation of 90 degrees requires that each phase shifter pair 105 produces a rotation of 0 to 18 degrees. To produce such a rotation, each permanent magnet and each switchable magnet must provide a Faraday rotation of θ=90/N=9 degrees

In operation, each crystal 115 is subjected to a flux by its corresponding permanent magnet 141 to provide a fixed predetermined rotation angle, 9 degrees for this embodiment, and each crystal 113 is subjected to a flux from its corresponding electromagnet 143. The flux from each electromagnet 143 is to produce a flux that switches. Each electromagnet 143 is configured to switches the magnetic polarity of the magnetic flux to switch the Faraday rotation in its corresponding crystal 113 between +9 degrees and −9 degrees. Each pair 105 of phase shifter produces a 0 to 18 degree phase shift and the combined result of the five phase shifter pairs is additive. Thus, by switching all of electromagnets 143, the combined phase shift produced is 0 to 90 degrees.

The non-reciprocal phase shifter 100 of FIG. 1 is simply assembled, with construction similar to that of optical isolators. Advantageously, non-reciprocal phase shifter 100 provides low insertion loss, low cost and small size.

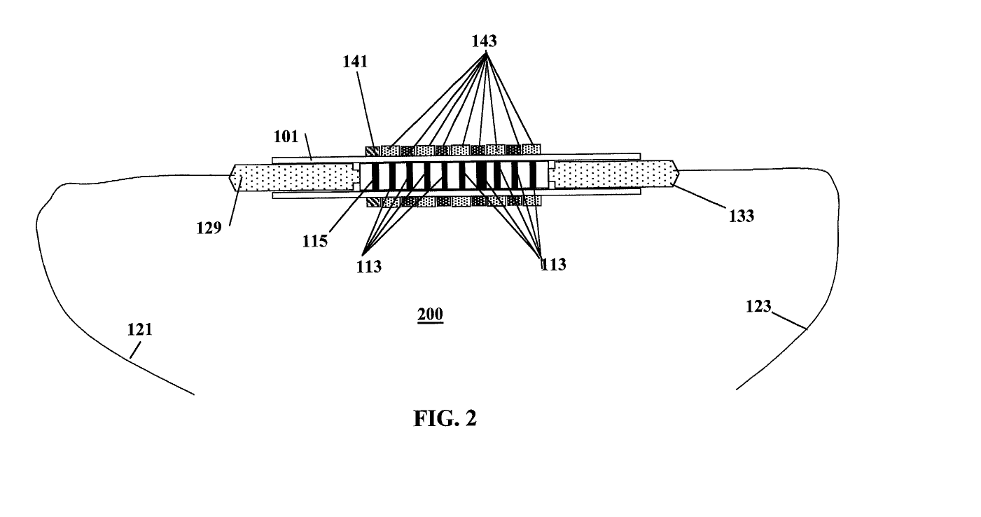

In a second embodiment of the invention, shown in FIG. 2, a non-reciprocal phase shifter 200 includes ten phase shifter stages to also produce a switchable non-reciprocal phase shift of 0 to 90 degrees. In non-reciprocal phase shifter 200, a single permanent magnet 141 is used, and a plurality, 9, of electromagnets 143 is utilized. The permanent magnet in combination with Faraday crystal 115 produces a fixed phase shift of +/−45 degrees. Each of the remaining phase shifter stages utilizes an electromagnet in conjunction with a corresponding Faraday crystal 113 to produce a phase shift of +/−5 degrees. With nine stages producing Faraday rotation of +/−5 degrees, the total phase shift produced by the nine Faraday crystals 113 is 9×(+/−5) =+/−45 degrees. The combined total phase shift of the ten phase shifter stages is 0 to +/−90 degrees.

In both embodiments, the Faraday rotation crystals are thin film crystals that in the illustrative embodiments are Bismuth Iron Garnet (BIG). In other embodiments, other Faraday rotation crystals such as Yttrium Iron Garnet (YIG) may be utilized.

As will be appreciated by those skilled in the art, various modifications can be made to the embodiments shown in the various drawing figures and described above without departing from the spirit or scope of the invention. In addition, reference is made to various directions in the above description. It will be understood that the directional orientations are with reference to the particular drawing layout and are not intended to be limiting or restrictive. It is not intended that the invention be limited to the illustrative embodiments shown and described. It is intended that the invention be limited in scope only by the claims appended hereto.

What is claimed is:

1. A non-reciprocal optical phase shifter, comprising:
a plurality of switchable phase shifter stages; each phase shifter stage being optically coupled to an adjacent phase shifter stage;
at least one phase shifter stage producing a fixed Faraday rotation on said optical signal components; said plurality of switchable phase shifter stages being optically coupled to said at least one phase shifter stage to produce a cumulative non-reciprocal phase shift that is the summation of the phase shifts of said plurality of switchable phase shifter stages and said at least one phase shifter stage.

2. A non-reciprocal phase shifter in accordance with claim 1, wherein:
each of said switchable phase shifter stages comprises a Faraday crystal and a corresponding electromagnet.

3. A non-reciprocal phase shifter in accordance with claim 2, wherein:
said at least one phase shifter stage comprises at least one Faraday crystal and a corresponding non-switchable magnet.

4. A non-reciprocal phase shifter in accordance with claim 1, wherein:
said at least one phase shifter stage comprises a plurality of phase shifter stages.

5. A non-reciprocal phase shifter in accordance with claim 1, wherein:
said at least one phase shifter comprises a single phase shifter.

6. A non-reciprocal phase shifter in accordance with claim 1, comprising:
a housing all of said plurality of switchable phase shifter stages and said at least one phase shifter stage.

7. A non-reciprocal phase shifter in accordance with claim 1, wherein:
all of said plurality of switchable phase shifter stages and said at least one phase shifter stage are in axial alignment.

8. A non-reciprocal optical phase shifter, comprising;
a plurality of phase shifters arranged in pairs;
each phase shifter pair comprising: first and second Faraday rotation crystals; a non-switchable magnet proximate said first Faraday rotation crystal; and a switchable magnet proximate said second Faraday rotation crystal; said first and second Faraday rotation crystals being optically coupled; and
said plurality of phase shifters being optically coupled together whereby the output of said non-reciprocal phase shifter is the summation of phase shifts of said plurality of phase shifters.

9. A non-reciprocal optical phase shifter, comprising:
a first phase shifter providing a fixed Faraday rotation to optical signals propagating there through;
a plurality of second phase shifters optically coupled to said first phase shifter and to each other, each of said second phase shifters being operable to provide a cumulative switchable phase shift.

10. A non-reciprocal phase shifter in accordance with claim 9, wherein:
said first phase shifter comprises a Faraday rotation crystal and a permanent magnet subjecting said Faraday rotation crystal to a fixed magnetic flux.

11. A non-reciprocal phase shifter in accordance with claim 10, wherein:
each of said plurality of phase shifters comprises a Faraday rotation crystal and a corresponding switchable magnetic source.

12. A non-reciprocal phase shifter in accordance with claim 11, wherein:
each said corresponding switchable magnetic source comprises a solenoid coil.

13. A non-reciprocal phase shifter in accordance with claim 11, wherein:
each said corresponding switchable magnetic source comprises an electromagnet.

14. A non-reciprocal phase shifter, comprising:
a first plurality of switchable phase shifters, each comprising a waveguide body of a material that, when subjected to magnetic fields causes Faraday rotation effects on optical signal components in said waveguide body; and a magnetic field source proximate said waveguide body, said magnetic field source subjecting said waveguide body to a magnetic field, said magnetic field source being changeable to change said magnetic field between first and second magnetic levels to provide a changeable non-reciprocal optical phase shift in optical signal components traversing said waveguide body in opposite directions; and
at least one second phase shifter comprising a waveguide body of a material that, when subjected to magnetic fields causes Faraday rotation effects on optical signal components, and a corresponding second magnetic field source disposed proximate said waveguide body and subjecting said waveguide body to a first fixed magnetic field such that first predetermined non-reciprocal optical phase shifts are produced in optical components traversing said at least one second phase shifter.

15. A non-reciprocal optical phase shifter in accordance with claim 14, comprising:
a single housing containing said plurality of non-reciprocal phase shifter stages.

16. A non-reciprocal phase shifter in accordance with claim 15, wherein:
each said first waveguide body of said switchable phase shifters comprises a first Faraday rotator crystal; and
said waveguide body of said second phase shifter comprises a second Faraday rotator crystal.

17. A non-reciprocal optical phase shifter in accordance with claim 16, wherein:
said each of said first and second Faraday rotator crystals comprises a crystal of Bismuth Iron Garnet.

18. A non-reciprocal optical phase shifter in accordance with claim 17, wherein:
said second magnetic field source comprises a permanent magnet.

19. A non-reciprocal optical phase shifter in accordance with claim 18, wherein:
each said first magnetic field source comprises an electromagnet.

20. A non-reciprocal optical phase shifter in accordance with claim 19, wherein:
each said electromagnet is operable to change said second magnetic field between two levels.

21. A non-reciprocal optical phase shifter in accordance with claim 14, wherein:
said first and said second bodies each comprise Bismuth Iron Garnet.

22. A non-reciprocal phase shifter in accordance with claim 14, wherein:
said second magnetic field source comprises a permanent magnet.

23. A non-reciprocal optical phase shifter in accordance with claim 22, wherein:
each said second magnetic field source comprises an electromagnet.

24. A non-reciprocal optical phase shifter in accordance with claim 23, wherein:
each said electromagnet is operable to change said second magnetic field between two levels.
